(19) United States
(12) Patent Application Publication
(10) Pub. No.: US 2026/0292227 A1
(43) Pub. Date: Sep. 24, 2026

(54) AN APPARATUS, A METHOD AND A COMPUTER PROGRAM FOR VIDEO

(71) Applicant: Nokia Technologies Oy, Espoo (FI)

(72) Inventors: Sebastian SCHWARZ, Munich (DE); Ramin GHAZNAVI YOUVALARI, Tampere (FI); Miska Matias HANNUKSELA, Tampere (FI)

(21) Appl. No.: 19/473,335

(22) PCT Filed: Mar. 11, 2024
(86) PCT No.: PCT/FI2024/050102

§ 371 Date: Oct. 7, 2025

(30) Foreign Application Priority Data
Apr. 11, 2023 (FI) 20235408

(51) Int. Cl. H04N 19/44; H04N 19/117; H04N 19/70; H04N 19/82

(52) U.S. Cl. CPC H04N 19/44; H04N 19/117; H04N 19/70; H04N 19/82

(57) ABSTRACT

A method comprising: obtaining a video signal comprising blocks of video frames, said blocks comprising a plurality of pixels (500); obtaining information indicative about reconstruction or visibility of said pixels in said blocks upon decoding (502); and disabling, based on said information indicative about reconstruction or visibility of said pixels in said blocks, in-loop filtering for such blocks having only a subset of the pixels to be reconstructed or visible upon decoding (504).

### TECHNICAL FIELD

The present invention relates to an apparatus, a method and a computer program for video coding.

### BACKGROUND

The video frames representing content may be provided with an accompanying reconstruction signal for controlling the reconstruction or visibility of parts of the frame, or even single pixels, upon decoding. One example of such an accompanying reconstruction signal is an occupancy picture (a.k.a. occupancy map or occupancy component) used in MPEG Visual Volumetric Video-based coding (V3C). The occupancy component can inform a V3C decoding and/or rendering system of which samples in the 2D components are associated with data in the final 3D representation. Another example is an alpha channel (a.k.a. alpha mask) providing parts of the frame, or even single pixels, with an alpha value defining its level of transparency.

Modern video codecs utilise in-loop filtering to reduce coding artefacts caused e.g. by quantised transform coefficients. In-loop filtering, such as deblocking filtering (DBF), adaptive loop filtering (ALF), sample adaptive offset (SAO), work well on traditional 2D video content.

However, for video content provided with an accompanying reconstruction signal such filtering may lead to unwanted distortions and decreased coding efficiency when applied on areas not intended for reconstruction, for example, areas in geometry and attribute videos with a corresponding occupancy map video area set to 0 for V3C video, or areas with an alpha mask set to fully transparent.

### SUMMARY

Now, an improved method and technical equipment implementing the method has been invented, by which the above problems are alleviated. Various aspects include a method, an apparatus and a computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising means for obtaining a video signal comprising blocks of video frames, said blocks comprising a plurality of pixels; means for obtaining information indicative about reconstruction or visibility of said pixels in said blocks upon decoding; and means for disabling, based on said information indicative about reconstruction or visibility of said pixels in said blocks, in-loop filtering for such blocks having only a subset of the pixels to be reconstructed or visible upon decoding.

According to an embodiment, the information indicative about reconstruction or visibility of said pixels in said blocks upon decoding is one or more of the following:
an occupancy map video;
an occupancy signal;
an alpha map video;
an alpha channel.

According to an embodiment, the block is one of a coding unit (CU), a prediction unit (PU), a transform unit (TU), a coding tree unit (CTU), a slice or a sub-picture.

According to an embodiment, the apparatus comprises means for excluding samples corresponding pixels not becoming reconstructed or visible upon decoding from a filter parameter derivation phase.

According to an embodiment, the apparatus comprises means for including only samples corresponding to pixels in a boundary area of pixels being reconstructed or becoming visible and non-visible upon decoding in a filter parameter derivation phase.

According to an embodiment, the apparatus comprises means for adjusting a filter strength for said samples corresponding to pixels in said boundary area of the pixels being reconstructed or becoming visible and non-visible upon decoding.

According to an embodiment, the apparatus comprises means for calculating a dedicated class of filters for a block comprising pixels becoming both visible and non-visible upon decoding.

According to an embodiment, the apparatus comprises means for using only a subset of in-loop filters for a block comprising pixels becoming both visible.

According to an embodiment, the apparatus comprises means for applying a combination of in-loop filters block-wise and/or pixel-wise.

According to an embodiment, the apparatus comprises means for fully or partially deactivating one or more in-loop filters for a block comprising only pixels not becoming visible upon decoding.

According to an embodiment, the apparatus comprises means for signaling one or more parameters about applicability of the in-loop filters in or along a bitstream comprising said video signal.

According to an embodiment, the apparatus comprises means for carrying out said signalling in a video parameter set raw byte sequence payload (RBSP) syntax or a sequence parameter set raw byte sequence payload (RBSP) syntax, wherein said signaling comprises a flag indicating activation of reconstruction guided in-loop filtering.

An apparatus according to a second aspect comprises at least one processor and at least one memory, said at least one memory stored with computer program code thereon, the at least one memory and the computer program code configured to, with the at least one processor, cause the apparatus at least to perform: obtain a video signal comprising blocks of video frames, said blocks comprising a plurality of pixels; obtain information indicative about reconstruction or visibility of said pixels in said blocks upon decoding; and disable, based on said information indicative about reconstruction or visibility of said pixels in said blocks, in-loop filtering for such blocks having only a subset of the pixels to be reconstructed or visible upon decoding.

A method according to a third aspect comprises obtaining a video signal comprising blocks of video frames, said blocks comprising a plurality of pixels; obtaining information indicative about reconstruction or visibility of said pixels in said blocks upon decoding; and disabling, based on said information indicative about reconstruction or visibility of said pixels in said blocks, in-loop filtering for such blocks having only a subset of the pixels to be reconstructed or visible upon decoding.

An apparatus according to a fourth aspect comprises means for receiving a bitstream comprising an encoded video signal comprising blocks of video frames, said blocks comprising a plurality of pixels; means for receiving, in or along said bitstream, information indicative about reconstruction or visibility of said pixels in said blocks; and means for decoding the encoded video signal according to at least said information indicative about reconstruction or visibility of said pixels in said blocks by disabling in-loop filtering for such blocks having only a subset of the pixels to be reconstructed or visible.

An apparatus according to a fifth aspect comprises at least one processor and at least one memory, said at least one memory stored with computer program code thereon, the at least one memory and the computer program code configured to, with the at least one processor, cause the apparatus at least to perform: receive a bitstream comprising an encoded video signal comprising blocks of video frames, said blocks comprising a plurality of pixels; receive, in or along said bitstream, information indicative about reconstruction or visibility of said pixels in said blocks; and decode the encoded video signal according to at least said information indicative about reconstruction or visibility of said pixels in said blocks by disabling in-loop filtering for such blocks having only a subset of the pixels to be reconstructed or visible.

A method according to a sixth aspect comprises receiving a bitstream comprising an encoded video signal comprising blocks of video frames, said blocks comprising a plurality of pixels; receiving, in or along said bitstream, information indicative about reconstruction or visibility of said pixels in said blocks; and decoding the encoded video signal according to at least said information indicative about reconstruction or visibility of said pixels in said blocks by disabling in-loop filtering for such blocks having only a subset of the pixels to be reconstructed or visible.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIGS. 1a and 1b show an encoder and decoder for encoding and decoding 2D pictures;

FIG. 2 shows an example of an in-loop filter chain in VCC;

FIGS. 3a and 3b show a compression and a decompression process for V3C volumetric video;

FIG. 4 shows an example of different stages in reconstructing a V3C coded volumetric video;

FIG. 5 shows a flow chart for a sending/encoding method according to an embodiment;

FIG. 6 shows an example of different states for encoding a coding unit according to occupancy information; and

FIG. 7 shows a flow chart for a receiving/decoding method according to an embodiment.

### DETAILED DESCRIPTION OF SOME EXAMPLE EMBODIMENTS

A video codec comprises an encoder that transforms the input video into a compressed representation suited for storage/transmission, and a decoder that can un-compress the compressed video representation back into a viewable form. An encoder may discard some information in the original video sequence in order to represent the video in a more compact form (i.e. at lower bitrate).

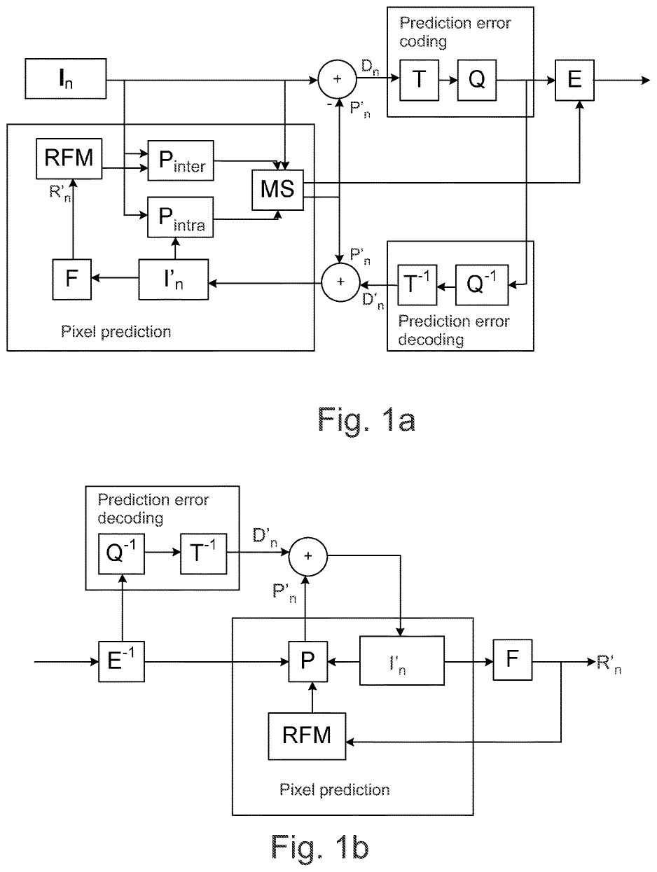

FIGS. 1a and 1b show an encoder and decoder for encoding and decoding 2D pictures. A video codec consists of an encoder that transforms an input video into a compressed representation suited for storage/transmission and a decoder that can uncompress the compressed video representation back into a viewable form. Typically, the encoder discards and/or loses some information in the original video sequence in order to represent the video in a more compact form (that is, at lower bitrate). An example of an encoding process is illustrated in FIG. 1a. FIG. 1a illustrates an image to be encoded (Iⁿ); a predicted representation of an image block (P′ⁿ); a prediction error signal (D′ⁿ); a reconstructed prediction error signal (D′ⁿ); a preliminary reconstructed image (I′ⁿ); a final reconstructed image (R′ⁿ); a transform (T) and inverse transform (T⁻¹); a quantization (Q) and inverse quantization (Q⁻¹); entropy encoding (E); a reference frame memory (RFM); inter prediction (Pᵢₙₜₑᵣ); intra prediction (Pᵢₙₜᵣₐ); mode selection (MS) and filtering (F).

An example of a decoding process is illustrated in FIG. 1b. FIG. 1b illustrates a predicted representation of an image block (P′ⁿ); a reconstructed prediction error signal (D′ⁿ); a preliminary reconstructed image (I′ⁿ); a final reconstructed image (R′ⁿ); an inverse transform (T⁻¹); an inverse quantization (Q⁻¹); an entropy decoding (E⁻¹); a reference frame memory (RFM); a prediction (either inter or intra) (P); and filtering (F).

Many hybrid video encoders, for example ITU-T H.263, H.264/AVC, HEVC, and VVC, encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate). Video codecs may also provide a transform skip mode, which the encoders may choose to use. In the transform skip mode, the prediction error is coded in a sample domain, for example by deriving a sample-wise difference value relative to certain adjacent samples and coding the sample-wise difference value with an entropy coder.

Many video encoders partition a picture into blocks along a block grid. For example, in the High Efficiency Video Coding (HEVC) standard, the following partitioning and definitions are used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples. A CU with the maximum allowed size may be named as LCU (largest coding unit) or coding tree unit (CTU) and the video picture is divided into non-overlapping LCUs.

In HEVC, a picture can be partitioned in tiles, which are rectangular and contain an integer number of LCUs. In HEVC, the partitioning to tiles forms a regular grid, where heights and widths of tiles differ from each other by one LCU at the maximum. In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order.

Entropy coding/decoding may be performed in many ways. For example, context-based coding/decoding may be applied, where in both the encoder and the decoder modify the context state of a coding parameter based on previously coded/decoded coding parameters. Context-based coding may for example be context adaptive binary arithmetic coding (CABAC) or context-adaptive variable length coding (CAVLC) or any similar entropy coding. Entropy coding/decoding may alternatively or additionally be performed using a variable length coding scheme, such as Huffman coding/decoding or Exp-Golomb coding/decoding. Decoding of coding parameters from an entropy-coded bitstream or codewords may be referred to as parsing.

The purpose of in-loop filtering is to reduce artifacts and distortions that can occur during the compression process. Compression techniques such as block-based motion compensation and discrete cosine transform (DCT) can introduce artifacts such as blocking, ringing, and blurring in the decoded video. In-loop filtering is designed to reduce these artifacts and improve the perceived visual quality of the video.

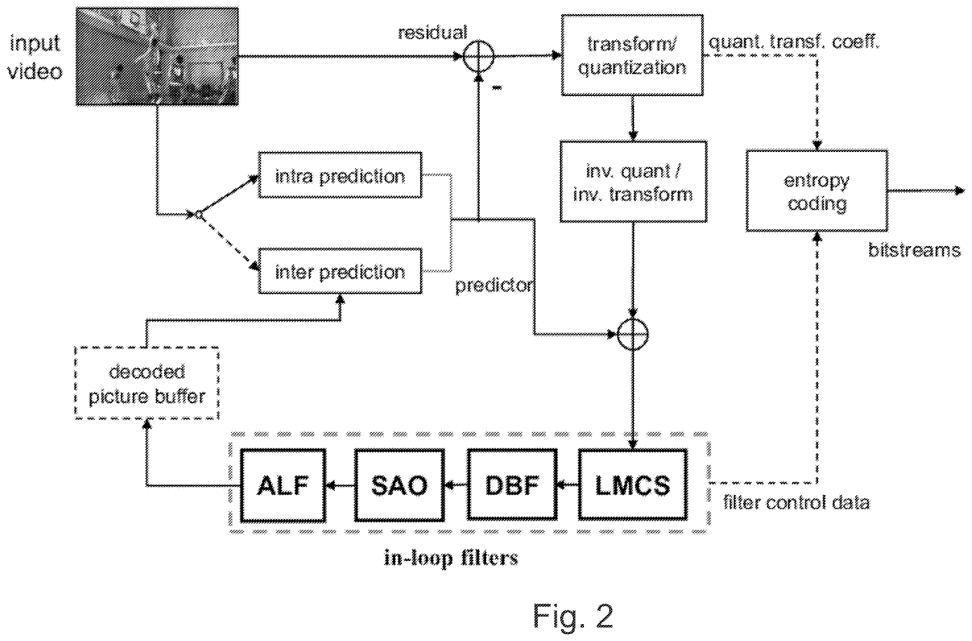

In-loop filters play a critical role in the maintenance of compressed video quality, since they can not only improve the quality of the current frame but can also provide a higher quality reference for subsequent frames. The in-loop filters in VVC are depicted in FIG. 2. Four processing steps, namely a luma mapping with chroma scaling (LMCS) process, followed by a deblocking filter (DBF), an SAO filter, and an adaptive loop filter (ALF) are applied to the reconstructed samples before writing them into the decoded picture buffer. The DBF and SAO are similar to that of the HEVC standard, whereas LMCS and ALF are newly introduced in VVC.

In VVC, in-loop filtering consists of a fixed-order chain of three filters including deblocking filter (DBF), sample adaptive offset (SAO) filter, and adaptive loop filter (ALF). A block-based ALF is used in VVC, which comprises luma ALF, chroma ALF and cross-component ALF (CC-ALF). The ALF filter coefficients are either pre-defined and fixed in both encoder and decoder or adaptively signaled on a picture basis using adaptation parameter set (APS). In order to enable merging of subpictures bitstreams (coded using independent encoder instances) into a single VVC-compliant picture without any ALF-APS identifiers conflict issue, the following solutions have been proposed:
Solution 1 (Disabled ALF): As a naïve method where no coordinated coding is required, ALF (i.e., both fixed ALF and ALF APS) is disabled to facilitate merging of different subpictures representations into a single picture at the cost of losing a substantial coding efficiency.
Solution 2 (Disabled ALF APS): the pre-defined fixed ALF is enabled, while the ALF APS usage is disabled for each subpicture, at the cost of disregarding the benefit of ALF parameter adaptation which comes with a coding efficiency.

The phrase along the bitstream (e.g. indicating along the bitstream) may be defined to refer to out-of-band transmission, signaling, or storage in a manner that the out-of-band data is associated with the bitstream. The phrase decoding along the bitstream or alike may refer to decoding the referred out-of-band data (which may be obtained from out-of-band transmission, signaling, or storage) that is associated with the bitstream. For example, an indication along the bitstream may refer to metadata in a container file that encapsulates the bitstream.

The video frames may be provided with an accompanying reconstruction signal for controlling the reconstruction or visibility of parts of the frame, or even single pixels, upon decoding. One example of such an accompanying reconstruction signal is an occupancy picture (a.k.a. occupancy map or occupancy component) used in MPEG Visual Volumetric Video-based coding (V3C). The occupancy component can inform a V3C decoding and/or rendering system of which samples in the 2D components are associated with data in the final 3D representation. Another example is an alpha channel (a.k.a. alpha mask) providing parts of the frame, or even single pixels, with an alpha value defining its level of transparency. As a more detailed example, V3C video coding is depicted more in detail further below to illustrate how the occupancy is used at the decoder to reconstruct an original 3D model.

A first texture picture may be encoded into a bitstream, and the first texture picture may comprise a first projection of texture data of a first source volume of a scene model onto a first projection surface. The scene model may comprise a number of further source volumes.

In the projection, data on the position of the originating geometry primitive may also be determined, and based on this determination, a geometry picture may be formed. This may happen for example so that depth data is determined for each or some of the texture pixels of the texture picture. Depth data is formed such that the distance from the originating geometry primitive such as a point to the projection surface is determined for the pixels. Such depth data may be represented as a depth picture, and similarly to the texture picture, such geometry picture (such as a depth picture) may be encoded and decoded with a video codec. This first geometry picture may be seen to represent a mapping of the first projection surface to the first source volume, and the decoder may use this information to determine the location of geometry primitives in the model to be reconstructed. In order to determine the position of the first source volume and/or the first projection surface and/or the first projection in the scene model, there may be first geometry information encoded into or along the bitstream. It is noted that encoding a geometry (or depth) picture into or along the bitstream with the texture picture is only optional and arbitrary for example in the cases where the distance of all texture pixels to the projection surface is the same or there is no change in said distance between a plurality of texture pictures. Thus, a geometry (or depth) picture may be encoded into or along the bitstream with the texture picture, for example, only when there is a change in the distance of texture pixels to the projection surface.

An attribute picture may be defined as a picture that comprises additional information related to an associated texture picture. An attribute picture may for example comprise surface normal, opacity, or reflectance information for a texture picture. A geometry picture may be regarded as one type of an attribute picture, although a geometry picture may be treated as its own picture type, separate from an attribute picture.

Texture picture(s) and the respective geometry picture(s), if any, and the respective attribute picture(s) may have the same or different chroma format.

Terms texture (component) image and texture (component) picture may be used interchangeably. Terms geometry (component) image and geometry (component) picture may be used interchangeably. A specific type of a geometry image is a depth image. Embodiments described in relation to a geometry (component) image equally apply to a depth (component) image, and embodiments described in relation to a depth (component) image equally apply to a geometry (component) image. Terms attribute image and attribute picture may be used interchangeably. A geometry picture and/or an attribute picture may be treated as an auxiliary picture in video/image encoding and/or decoding.

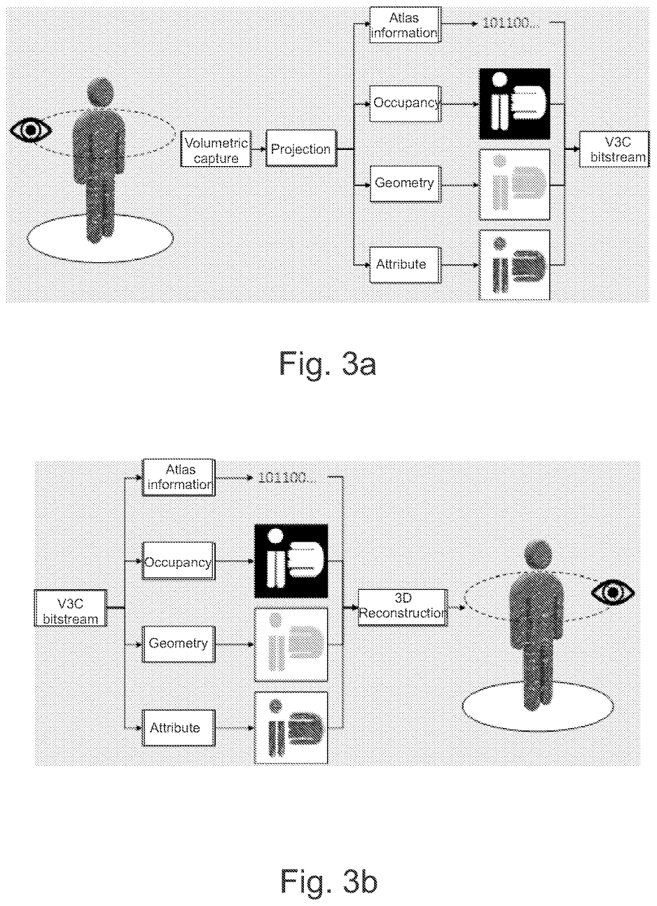

FIGS. 3a and 3b illustrate an overview of exemplified compression/decompression processes. The processes may be applied, for example, in MPEG visual volumetric video-based coding (V3C), defined currently in ISO/IEC DIS 23090-5: “Visual Volumetric Video-based Coding and Video-based Point Cloud Compression”, 2nd Edition.

V3C specification enables the encoding and decoding processes of a variety of volumetric media by using video and image coding technologies. This is achieved through first a conversion of such media from their corresponding 3D representation to multiple 2D representations, also referred to as V3C components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g. texture or material information, of such 3D data. An example of volumetric media conversion at an encoder is shown in FIG. 2a and an example of a 3D reconstruction at a decoder is shown in FIG. 3b.

A V3C decoder receives the three video bitstreams, alongside a V3C atlas bitstream and then reconstructs the volumetric video frame by frame as follows:
1. The decoder reconstructs the patch positions in 3D space based on the atlas bitstream;
2. The decoder reconstructs the patch shape according to the occupancy map signal;
3. The decoder reconstructs the 3D positions of each point per patch based on the geometry video;
4. The decoder applies attributes to each point, e.g. texture color.

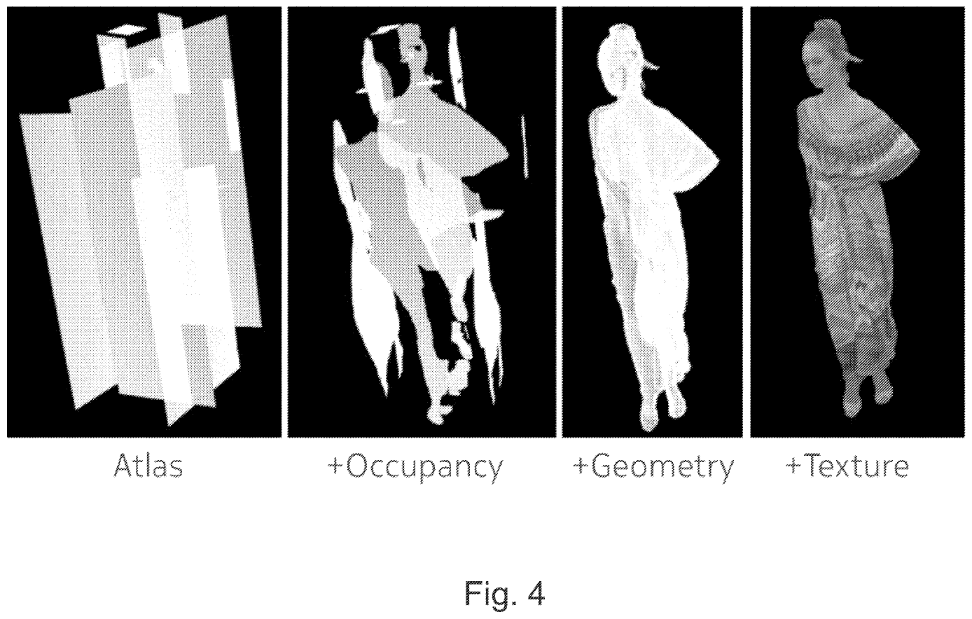

The different stages of this process are visualised in FIG. 4.

There are alternatives to capture and represent a volumetric frame. The format used to capture and represent the volumetric frame depends on the process to be performed on it, and the target application using the volumetric frame. As a first example a volumetric frame can be represented as a point cloud. A point cloud is a set of unstructured points in 3D space, where each point is characterized by its position in a 3D coordinate system (e.g., Euclidean), and some corresponding attributes (e.g., color information provided as RGBA value, or normal vectors). As a second example, a volumetric frame can be represented as images, with or without depth, captured from multiple viewpoints in 3D space. In other words, the volumetric video can be represented by one or more view frames (where a view is a projection of a volumetric scene on to a plane (the camera plane) using a real or virtual camera with known/computed extrinsic and intrinsic). Each view may be represented by a number of components (e.g., geometry, color, transparency, and occupancy picture), which may be part of the geometry picture or represented separately. As a third example, a volumetric frame can be represented as a mesh. Mesh is a collection of points, called vertices, and connectivity information between vertices, called edges. Vertices along with edges form faces. The combination of vertices, edges and faces can uniquely approximate shapes of objects.

Depending on the capture, a volumetric frame can provide viewers the ability to navigate a scene with six degrees of freedom, i.e., both translational and rotational movement of their viewing pose (which includes yaw, pitch, and roll). The data to be coded for a volumetric frame can also be significant, as a volumetric frame can contain many numbers of objects, and the positioning and movement of these objects in the scene can result in many dis-occluded regions. Furthermore, the interaction of the light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specification such as ISO/IEC 23090-5. The coded images and the associated metadata can be stored or transmitted to a client that can decode and render the 3D volumetric frame.

As described above, modern video codecs utilise in-loop filtering to reduce coding artefacts caused e.g. by quantised transform coefficients. In-loop filtering, such as deblocking filtering (DBF), adaptive loop filtering (ALF), sample adaptive offset (SAO), work well on traditional 2D video content.

However, for video content accompanied by a reconstruction signal, e.g. occupancy in V3C video or an alpha channel, such filtering may lead to unwanted distortions and decreased coding efficiency when applied on areas not intended for reconstruction at the decoder, i.e. areas in geometry and attribute videos with a corresponding occupancy map video area set to 0 for V3C or areas with a corresponding alpha channel set to fully transparent.

In the following, an enhanced method for will be described in more detail, in accordance with various embodiments.

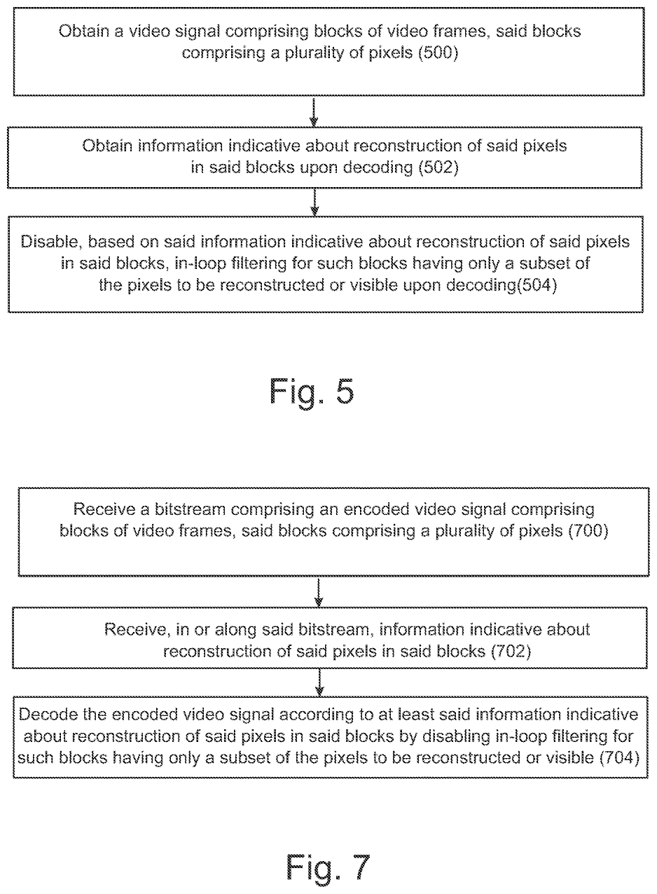

The method, which is disclosed in FIG. 5, comprises obtaining (500) a video signal comprising blocks of video frames, said blocks comprising a plurality of pixels; obtaining (502) information indicative about reconstruction or visibility of said pixels in said blocks upon decoding; and disabling (504), based on said information indicative about reconstruction or visibility of said pixels in said blocks, in-loop filtering for such blocks having only a subset of the pixels to be reconstructed or visible upon decoding.

Thus, the method enables to remove at least a part of distortion and increase the coding efficiency through reduced bitrate by activating and deactivating some or all video codec in-loop filters, based on a secondary input indicating information about reconstruction of said pixels in said blocks upon decoding, e.g. an occupancy signal. Based on this information, the encoder may disable in-loop filtering for such blocks having only a subset of the pixels to be reconstructed or visible upon decoding.

It is noted that herein the term “subset of pixels” refers to a block where at least one but not all pixels of the block are indicated to be reconstructed or visible upon decoding.

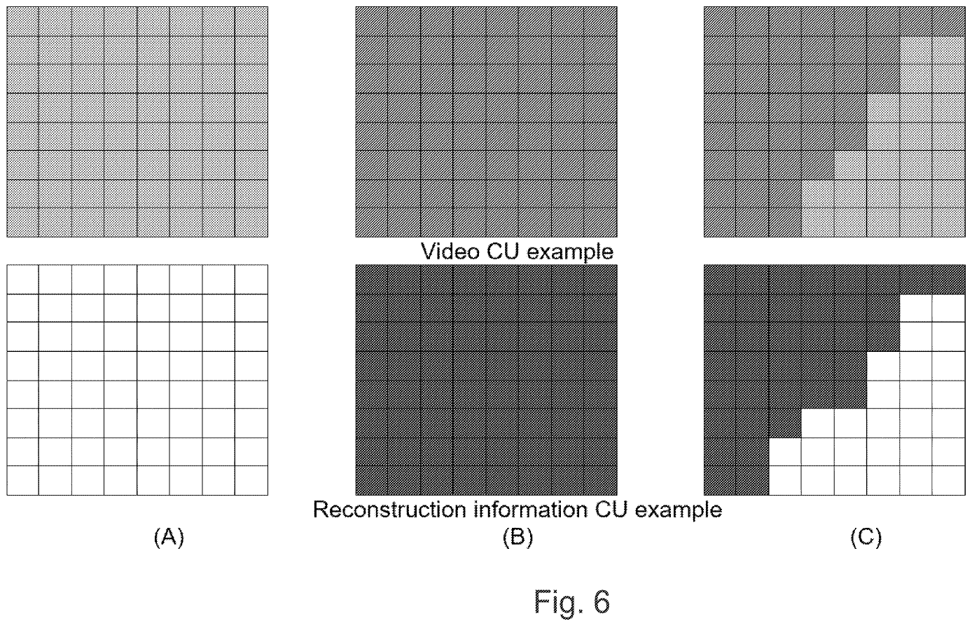

The principle underlying the method may be illustrated by an example shown in FIG. 6, which shows three possible states (A, B, C) for a block, such as an 8×8 pixel coding unit (CU). For each state, the upper block represents the video, i.e. the coding unit, whereas the lower block, i.e. a reconstruction information CU, represents the information indicative about reconstruction of said pixels in said blocks. White values in the reconstruction information CU indicate that the corresponding pixel is visible/reconstructed at the decoder and dark values indicate that the corresponding pixel is not visible/reconstructed at the decoder.

The three states may be summarized as follows:
A. All pixels (pel, sample-values) in the CU will be reconstructed/visible at the decoder;
B. None of the pixels in the CU will be reconstructed/visible at the decoder;
C. Some (a subset) of the pixels in the CU will be reconstructed/visible at the decoder.

Based on these states, the encoder adaptively guides the in-loop filtering process for each state, such as follows:
A. Visual distortion will be visible at the decoder, but CU content represents “typical” video content and in-loop filter are expected to perform optimal. No changes are made to the in-loop filtering process, and the RDO calculations may be kept original.
B. Visual distortion will not be visible at the decoder, thus no changes to the in-loop filtering process are required. The RDO calculations may be optimized to favor less reduced rate over increased distortion.
C. A subset of the pixels in the CU will be reconstructed/visible at the decoder, whereupon the visual distortion will be visible. The boundaries introduced due to occupancy information within the CU change the video content characteristic. as a result, in-loop filter(s) fail to perform optimally, and they are therefore disabled.

According to an embodiment, the information indicative about reconstruction or visibility of said pixels in said blocks upon decoding is one or more of the following:
an occupancy map video;
an occupancy signal;
an alpha map video;
an alpha channel.

Herein, the occupancy map video addresses the V3C V-PCC use case by indicating which pixel positions will be reconstructed/visible at the decoder. The occupancy signal, which may be multiplexed in the same or yet another video, addresses the V3C MIV use case by indicating which pixel positions will be reconstructed/visible at the decoder, wherein, for example, values below a certain offset are considered unoccupied. The alpha map video and alpha channel correspondingly addresses the Alpha use case.

According to an embodiment, the video signal comprises one or more of the following:
individual video streams;
separate layers for multi-layer coding;
separate sublayers;
separate pictures in a temporally interleaved manner in the same coded layer video sequence;
separate constituent frames in spatially frame-packed video.

According to an embodiment, the block is one of a coding unit (CU), a prediction unit (PU), a transform unit (TU), a coding tree unit (CTU), a slice or a sub-picture.

Thus, the size of the block to be processed is irrespective for the implementation.

According to an embodiment, the method comprises excluding samples corresponding pixels not becoming visible upon decoding from a filter parameter derivation phase.

Accordingly, when the visual distortion will not be visible at the decoder side, i.e., case B in above, the corresponding samples in the encoder side will be excluded from the filter parameter derivation phase. For example, the adaptive loop filter (ALF) training in the encoder side may use only samples that will be visible at the decoder side. In another examples, other filters such as luma mapping with chroma scaling (LMCS) and sample adaptive offset filter (SAO) may follow the same principles.

According to an embodiment, the method comprises including only samples corresponding to pixels in a boundary area of pixels becoming visible and non-visible upon decoding in a filter parameter derivation phase.

Thus, among the samples whose visual distortion will not be visible at decoder side, only those samples that are in the boundary areas of the visible and non-visible samples for the decoder may be used in the encoder side for training the in-loop filters, such as ALF and SAO. An example of such boundary area is demonstrated in state C of FIG. 6. Including such samples may guide the in-loop filters by classifying those boundary areas more accurately and hence the resulting filtering process may perform more optimally.

According to an embodiment, the method comprises adjusting a filter strength for said samples corresponding to pixels in said boundary area of the pixels becoming visible and non-visible upon decoding.

When the filtering is applied to blocks containing both visible and non-visible samples at the decoder (e.g., state C of FIG. 6), the filter strength may be adjusted in such a way that it has weaker impact to the samples in the boundary areas of the two sample types. For example, a weaker deblocking filter may be considered in such areas. As a result, the weaker filtering may still reduce the coding artifacts while preserving the object edges in the boundary regions of the two sample types.

According to an embodiment, the method comprises calculating a dedicated class of filters for a block comprising pixels becoming both visible and non-visible upon decoding.

Consequently, a dedicated class of filters may be calculated for the blocks that include both visible and non-visible samples for the decoder (e.g., state C of FIG. 6). For example, the ALF filter may contain one or more classes of filters trained for such cases. In the decoder side, the available occupancy information may be used for indicating the filter class based on the content.

According to an embodiment, the method comprises disabling all in-loop filters for a block comprising pixels becoming both visible and non-visible upon decoding.

Thus, the encoder may disable all in-loop filter for blocks, such as CUs, containing partially reconstructed/visible content.

According to an embodiment, the method comprises using only a subset of in-loop filters for a block comprising pixels becoming both visible and non-visible upon decoding.

Hence, the encoder may only use a subset of in-loop filters for blocks, such as CUs, containing partially reconstructed/visible content. For example, the encoder may only use LMCS and SAO, while disabling DBF and ALF.

According to an embodiment, the method comprises applying at least one in-loop filter for only pixels of a block becoming visible upon decoding.

As an alternative, the encoder does not disable in-loop filters, however, the filter is only applied on pixel marked as visible/reconstructed at the decoder, while other pixels retain their original value.

According to an embodiment, the method comprises applying a combination of in-loop filters block-wise and/or pixel-wise.

Thus, the encoder may apply or disable one or more in-loop filters on a block level, and at the same time, apply or disable one or more in-loop filters on a pixel level. For example, DBF may be disabled per-CU, whereas ALF is applied per-pixel.

According to an embodiment, the method comprises fully or partially deactivating one or more in-loop filters for a block comprising only pixels not becoming visible upon decoding.

Accordingly, for the blocks that contain only the non-visible sample types (e.g., state B of FIG. 6) at the decoder, the one or more of the in-loop filters may be fully or partially deactivated.

According to an embodiment, the method comprises skipping a signaling of filter information for said fully or partially deactivated one or more in-loop filters.

Thus, signaling of the filter information for the one or more in-loop filters of the underlying codec may be also skipped and a pre-defined values may be assigned for the in-loop filters. The filter information, as such, may comprise one or more of the following: filter activation, filter type, filter class and index, etc.

According to an embodiment, the method comprises signaling one or more parameters about applicability of the in-loop filters in or along a bitstream comprising said video signal.

Hence, further aspects of the invention relate to signaling of reconstruction guided in-loop filtering, which may be performed, for example, in or along the bitstream of the video signal. In the following, various example embodiments for carrying the signaling are given.

According to an embodiment, the method comprises carrying out said signalling in a video parameter set raw byte sequence payload (RBSP) syntax or a sequence parameter set raw byte sequence payload (RBSP) syntax, wherein said signaling comprises a flag indicating activation of reconstruction guided in-loop filtering.

Examples of the signaling are given below:

| | Descriptor |
|---|---|
| video_parameter_set_rbsp( ) { | |
| ... | |
| vps_reconstruction_guided_inloop_present_flag | u(1) |
| ... | |
| } | |

| | Descriptor |
|---|---|
| seq_parameter_set_rbsp( ) { | |
| ... | |
| sps_reconstruction_guided_inloop_present_flag | u(1) |
| ... | |
| } | |

In the examples above, a new syntax element vps/sps_reconstruction_guided_inloop_present_flag is introduced, wherein the flag value equal to 0 specifies that reconstruction guided in-loop filtering is not activated, and the flag value equal to 1 specifies that reconstruction guided in-loop filtering is activated.

According to an alternative embodiment, the method comprises signaling one or more parameters about applicability of the in-loop filters as a supplemental enhancement information (SEI) message.

According to an embodiment, said signaling comprises a reference to a reconstruction guided in-loop filtering as part of a multi-layer encoding structure.

An example of such signaling is given below:

| | Descriptor |
|---|---|
| video_parameter_set_rbsp( ) { | |
| ... | |
| vps_reconstruction_guided_inloop_present_flag | u(1) |
| if( vps_reconstruction_guided_inloop_present_flag ) { | |
| vps_reconstruction_layer_id | u(6) |
| } | |

}

Herein, a new syntax element vps_reconstruction_layer_id specifies the nuh_layer_id value of the layer carrying the reconstruction information relevant for reconstruction guided in-loop filter.

According to an embodiment, the signaling comprises indicating a layer using the reconstruction guided in-loop filtering per a dependent layer.

An example of such signaling is given below:

| | Descriptor |
|---|---|
| video_parameter_set_rbsp( ) { | |
| ... | |
| for( i = 0; vps_reconstruction_guided_inloop_present_flag && | |
| i <= vps_max_layers_minus1; i++ ) | |
| if( !vps_independent_layer_flag[ i ] ) { | |
| vps_reconstruction_guided_inloop_layer_flag[ i ] | u(1) |
| if( vps_reconstruction_guided_inloop_layer_flag[ i ] ) | |
| vps_reconstruction_layer_idx[ i ] | ue(v) |
| } | |
| ... | |
| } | |

Herein, a new syntax element vps_reconstruction_guided_inloop_layer_flag[i] having a value equal to 1 specifies that the i-th layer uses reconstruction guided in-loop filtering. vps_reconstruction_guided_inloop_layer_flag[i] equal to 0 specifies that the i-th layer does not use reconstruction guided in-loop filtering. A new syntax element vps_reconstruction_layer_idx[i] specifies that the layer index for the reconstuction information for the i-th layer is ReferenceLayerIdx[i][vps_reconstruction_layer_idx[i]].

According to an embodiment, the signaling comprises indicating an activation of one or more in-loop filters individually.

An example of such signaling is given below:

| | Descriptor |
|---|---|
| video_parameter_set_rbsp( ) { | |
| ... | |
| vps_reconstruction_guided_inloop_present_flag | u(1) |
| if( vps_reconstruction_guided_inloop_present_flag ) { | |
| vps_reconstruction_lmcs_flag | u(1) |
| vps_reconstruction_dbf_flag | u(1) |
| vps_reconstruction_sao_flag | u(1) |
| vps_reconstruction_alf_flag | u(1) |
| } | |
| } | |

Herein, new syntax elements are introduced:

vps_reconstruction_lmcs_flag equal to 0 specifies that LMCS in-loop filter is not applied if partial reconstruction information is available. vps_reconstruction_lmcs_flag equal to 1 specifies that LMCS in-loop filter is applied if partial reconstruction information is available.

vps_reconstruction_dbf_flag equal to 0 specifies that DBF in-loop filter is not applied if partial reconstruction information is available. vps_reconstruction_dbf_flag equal to 1 specifies that DBF in-loop filter is applied if partial reconstruction information is available.

vps_reconstruction_sao_flag equal to 0 specifies that SAO in-loop filter is not applied if partial reconstruction information is available. vps_reconstruction_sao_flag equal to 1 specifies that SAO in-loop filter is applied if partial reconstruction information is available.

vps_reconstruction_alf_flag equal to 0 specifies that ALF in-loop filter is not applied if partial reconstruction information is available. vps_reconstruction_alf_flag equal to 1 specifies that ALF in-loop filter is applied if partial reconstruction information is available.

According to an embodiment, the signaling comprises both a flag indicating activation of reconstruction guided in-loop filtering and indication for an activation of one or more in-loop filters individually.

An example of such signaling is given below:

| | Descriptor |
|---|---|
| video_parameter_set_rbsp( ) { | |
| ... | |
| vps_reconstruction_guided_inloop_present_flag | u(1) |
| if( vps_reconstruction_guided_inloop_present_flag ) { | |
| vps_reconstruction_lmcs_flag | u(2) |
| vps_reconstruction_dbf_flag | u(2) |
| vps_reconstruction_sao_flag | u(2) |
| vps_reconstruction_alf_flag | u(2) |
| } | |
| } | |

Herein, the flag values are indicated by two bits, thereby enabling more versatile signaling. New syntax elements are introduced as follows:

vps_reconstruction_lmcs_flag equal to 0 specifies that LMCS in-loop filter is not applied if partial reconstruction information is available. vps_reconstruction_lmcs_flag equal to 1 specifies that LMCS in-loop filter is applied if partial reconstruction information is available per CU. vps_reconstruction_lmcs_flag equal to 2 specifies that LMCS in-loop filter is applied only to sample with reconstruction information available.

vps_reconstruction_dbf_flag equal to 0 specifies that DBF in-loop filter is not applied if partial reconstruction information is available. vps_reconstruction_dbf_flag equal to 1 specifies that DBF in-loop filter is applied if partial reconstruction information is available per CU. vps_reconstruction_lmcs_flag equal to 2 specifies that DBF in-loop filter is applied only to sample with reconstruction information available.

vps_reconstruction_sao_flag equal to 0 specifies that SAO in-loop filter is not applied if partial reconstruction information is available. vps_reconstruction_sao_flag equal to 1 specifies that SAO in-loop filter is applied if partial reconstruction information is available per CU. vps_reconstruction_lmcs_flag equal to 2 specifies that SAO in-loop filter is applied only to sample with reconstruction information available.

vps_reconstruction_alf_flag equal to 0 specifies that ALF in-loop filter is not applied if partial reconstruction information is available. vps_reconstruction_alf_flag equal to 1 specifies that ALF in-loop filter is applied if partial reconstruction information is available per CU. vps_reconstruction_lmcs_flag equal to 2 specifies that ALF in-loop filter is applied only to sample with reconstruction information available.

In another embodiment, one or more threshold syntax elements that control the use of the reconstruction information for in-loop filtering are included by an encoder in or along a bitstream, such as in a VPS, and/or decoded by a decoder from or along a bitstream, such as from a VPS. A threshold syntax element may for example define the sample value range in the reconstruction information that indicates a non-visible pixel for in-loop filtering.

The following syntax table provides an example, where numReconstructionInformationLayers is a variable indicating the number of layers that contain reconsruction information to be used for guided in-loop filtering:

| | Descriptor |
|---|---|
| video_parameter_set_rbsp( ) { | |
| ... | |
| for( i = 0; i < numReconstrictionInformationLayers; i++ ) | |
| vps_reconstruction_luma_threshold[ i ] | u(v) |
| ... | |
| } | |

Herein, the syntax element vps_reconstruction_luma_threshold[i] specifies that samples with luma sample value in the range of 0 to vps_reconstruction_luma_threshold[i], inclusive, indicate non-visible samples for in-loop filtering.

Another aspect relates to the operation of a decoder (or a renderer/receiver/player/client). The method, which is disclosed in FIG. 7 as illustrating the operation of a decoder, comprises receiving (700) a bitstream comprising an encoded video signal comprising blocks of video frames, said blocks comprising a plurality of pixels; receiving (702), in or along said bitstream, information indicative about reconstruction or visibility of said pixels in said blocks; decoding (704) the an encoded video signal according to at least said information indicative about reconstruction or visibility of said pixels in said blocks by disabling in-loop filtering for such blocks having only a subset of the pixels to be reconstructed or visible.

Hence, the decoding apparatus receives a bitstream, containing reconstruction guided in-loop filter signalling as disclosed above, and comprising encoded video data, and in or along the bitstream the reconstruction information. The reconstruction information may be provided in the form of a bitstream comprising an encoded occupancy (V3C use case) or alpha map video, either as individual videos (V3C V-PCC use case) or as layer in a multi-layer encoding, or a reconstruction signal, multiplexed in the same or yet another video (V3C MIV use case). If necessary, the decoder first decodes the reconstruction information, then the decoder decodes the video data, activating/disabling in-loop filters according to said information indicative about reconstruction or visibility of said pixels in said blocks, i.e. reconstruction information state (full, none, partial) and the received signaling.

According to an embodiment, any of the embodiments disclosed above, relating to either encoding or decoding, may be applied similarly to a post-processing filter. For a neural-network post-processing filter, an input tensor may be formed. In an embodiment, it may be indicated by an encoder, e.g. in a neural-network post-filter characteristics (NNPFC) SEI message, that the post-filter expects auxiliary input in the input tensor for the reconstruction information and/or variables controlling the reconstruction information guided filtering, such as one or more threshold values defining the sample value range in the reconstruction information that indicates a non-visible pixel for filtering. In an embodiment, it may be decoded by a decoder, e.g. from a NNPFC SEI message, that the post-filter expects auxiliary input in the input tensor for the reconstruction information and/or variables controlling the reconstruction information guided filtering. Accordingly, the decoder forms an input tensor with reconstruction information and/or variables controlling the reconstruction information guided filtering.

The embodiments relating to the sending/encoding aspects may be implemented in an apparatus comprising: means for obtaining a video signal comprising blocks of video frames, said blocks comprising a plurality of pixels; means for obtaining information indicative about reconstruction or visibility of said pixels in said blocks upon decoding; and means for disabling, based on said information indicative about reconstruction or visibility of said pixels in said blocks, in-loop filtering for such blocks having only a subset of the pixels to be reconstructed or visible upon decoding.

According to an embodiment, the information indicative about reconstruction or visibility of said pixels in said blocks upon decoding is one or more of the following:
an occupancy map video;
an occupancy signal;
an alpha map video;
an alpha channel.

According to an embodiment, the block is one of a coding unit (CU), a prediction unit (PU), a transform unit (TU), a coding tree unit (CTU), a slice or a sub-picture.

According to an embodiment, the apparatus comprises means for excluding samples corresponding pixels not becoming reconstructed or visible upon decoding from a filter parameter derivation phase.

According to an embodiment, the apparatus comprises means for including only samples corresponding to pixels in a boundary area of pixels being reconstructed or becoming visible and non-visible upon decoding in a filter parameter derivation phase.

According to an embodiment, the apparatus comprises means for adjusting a filter strength for said samples corresponding to pixels in said boundary area of the pixels being reconstructed or becoming visible and non-visible upon decoding.

According to an embodiment, the apparatus comprises means for calculating a dedicated class of filters for a block comprising pixels becoming both visible and non-visible upon decoding.

According to an embodiment, the apparatus comprises means for using only a subset of in-loop filters for a block comprising pixels becoming both visible.

According to an embodiment, the apparatus comprises means for applying a combination of in-loop filters block-wise and/or pixel-wise.

According to an embodiment, the apparatus comprises means for fully or partially deactivating one or more in-loop filters for a block comprising only pixels not becoming visible upon decoding.

According to an embodiment, the apparatus comprises means for signaling one or more parameters about applicability of the in-loop filters in or along a bitstream comprising said video signal.

According to an embodiment, the apparatus comprises means for carrying out said signalling in a video parameter set raw byte sequence payload (RBSP) syntax or a sequence parameter set raw byte sequence payload (RBSP) syntax, wherein said signaling comprises a flag indicating activation of reconstruction guided in-loop filtering.

The embodiments relating to the sending/encoding aspects may likewise be implemented in an apparatus comprising at least one processor and at least one memory, said at least one memory stored with computer program code thereon, the at least one memory and the computer program code configured to, with the at least one processor, cause the apparatus at least to perform: obtain a video signal comprising blocks of video frames, said blocks comprising a plurality of pixels; obtain information indicative about reconstruction or visibility of said pixels in said blocks upon decoding; and disable, based on said information indicative about reconstruction or visibility of said pixels in said blocks, in-loop filtering for such blocks having only a subset of the pixels to be reconstructed or visible upon decoding.

According to an embodiment, the information indicative about reconstruction or visibility of said pixels in said blocks upon decoding is one or more of the following:
an occupancy map video;
an occupancy signal;
an alpha map video;
an alpha channel.

According to an embodiment, the block is one of a coding unit (CU), a prediction unit (PU), a transform unit (TU), a coding tree unit (CTU), a slice or a sub-picture.

According to an embodiment, the apparatus comprises code configured to cause the apparatus to exclude samples corresponding pixels not becoming reconstructed or visible upon decoding from a filter parameter derivation phase.

According to an embodiment, the apparatus comprises code configured to cause the apparatus to include only samples corresponding to pixels in a boundary area of pixels being reconstructed or becoming visible and non-visible upon decoding in a filter parameter derivation phase.

According to an embodiment, the apparatus comprises code configured to cause the apparatus to adjust a filter strength for said samples corresponding to pixels in said boundary area of the pixels being reconstructed or becoming visible and non-visible upon decoding.

According to an embodiment, the apparatus comprises code configured to cause the apparatus to calculate a dedicated class of filters for a block comprising pixels becoming both visible and non-visible upon decoding.

According to an embodiment, the apparatus comprises code configured to cause the apparatus to use only a subset of in-loop filters for a block comprising pixels becoming both visible.

According to an embodiment, the apparatus comprises code configured to cause the apparatus to apply a combination of in-loop filters block-wise and/or pixel-wise.

According to an embodiment, the apparatus comprises code configured to cause the apparatus to fully or partially deactivate one or more in-loop filters for a block comprising only pixels not becoming visible upon decoding.

According to an embodiment, the apparatus comprises code configured to cause the apparatus to signal one or more parameters about applicability of the in-loop filters in or along a bitstream comprising said video signal.

According to an embodiment, the apparatus comprises code configured to cause the apparatus to carry out said signalling in a video parameter set raw byte sequence payload (RBSP) syntax or a sequence parameter set raw byte sequence payload (RBSP) syntax, wherein said signaling comprises a flag indicating activation of reconstruction guided in-loop filtering.

The receiving/decoding/rendering aspects may be implemented by an apparatus comprising means for receiving a bitstream comprising an encoded video signal comprising blocks of video frames, said blocks comprising a plurality of pixels; means for receiving, in or along said bitstream, information indicative about reconstruction or visibility of said pixels in said blocks; and means for decoding the encoded video signal according to at least said information indicative about reconstruction or visibility of said pixels in said blocks by disabling in-loop filtering for such blocks having only a subset of the pixels to be reconstructed or visible.

The embodiments relating to the receiving/decoding/rendering aspects may likewise be implemented in an apparatus comprising at least one processor and at least one memory, said at least one memory stored with computer program code thereon, the at least one memory and the computer program code configured to, with the at least one processor, cause the apparatus at least to perform: receive a bitstream comprising an encoded video signal comprising blocks of video frames, said blocks comprising a plurality of pixels; receive, in or along said bitstream, information indicative about reconstruction or visibility of said pixels in said blocks; and decode the encoded video signal according to at least said information indicative about reconstruction or visibility of said pixels in said blocks by disabling in-loop filtering for such blocks having only a subset of the pixels to be reconstructed or visible.

Such apparatuses may comprise e.g. the functional units disclosed in any of the FIGS. 1a, 1b, 2, 3a and 3b for implementing the embodiments.

In the above, some embodiments have been described with reference to encoding. It needs to be understood that said encoding may comprise one or more of the following: encoding source image data into a bitstream, encapsulating the encoded bitstream in a container file and/or in packet(s) or stream(s) of a communication protocol, and announcing or describing the bitstream in a content description, such as the Media Presentation Description (MPD) of ISO/IEC 23009-1 (known as MPEG-DASH) or the IETF Session Description Protocol (SDP). Similarly, some embodiments have been described with reference to decoding. It needs to be understood that said decoding may comprise one or more of the following: decoding image data from a bitstream, decapsulating the bitstream from a container file and/or from packet(s) or stream(s) of a communication protocol, and parsing a content description of the bitstream,

In the above, where the example embodiments have been described with reference to an encoder or an encoding method, it needs to be understood that the resulting bitstream and the decoder or the decoding method may have corresponding elements in them. Likewise, where the example embodiments have been described with reference to a decoder, it needs to be understood that the encoder may have structure and/or computer program for generating the bitstream to be decoded by the decoder.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1. An apparatus comprising:
at least one processor; and
at least one memory storing instructions that when executed by the at least one processor cause the apparatus at least to perform:
obtaining a video signal comprising blocks of video frames, said blocks comprising a plurality of pixels;
obtaining information indicative about reconstruction or visibility of said pixels in said blocks upon decoding; and
disabling, based on said information indicative about reconstruction or visibility of said pixels in said blocks, in-loop filtering for such blocks having only a subset of the pixels to be reconstructed or visible upon decoding.

2. The apparatus according to claim 1, wherein the information indicative about reconstruction or visibility of said pixels in said blocks upon decoding is one or more of the following:
an occupancy map video;
an occupancy signal;
an alpha map video;
an alpha channel.

3. The apparatus according to claim 1, wherein the block is one of a coding unit (CU), a prediction unit (PU), a transform unit (TU), a coding tree unit (CTU), a slice or a sub-picture.

4. The apparatus according to claim 1, wherein the instructions when executed by the at least one processor cause the apparatus at least to perform:
excluding samples corresponding to pixels not becoming reconstructed or visible upon decoding from a filter parameter derivation phase.

5. The apparatus according to claim 1, wherein the instructions when executed by the at least one processor cause the apparatus at least to perform:
including only samples corresponding to pixels in a boundary area of pixels being reconstructed or becoming visible and non-visible upon decoding in a filter parameter derivation phase.

6. The apparatus according to claim 5, wherein the instructions when executed by the at least one processor cause the apparatus at least to perform
adjusting a filter strength for said samples corresponding to pixels in said boundary area of the pixels being reconstructed or becoming visible and non-visible upon decoding.

7. The apparatus according to claim 1, wherein the instructions when executed by the at least one processor cause the apparatus at least to perform
calculating a dedicated class of filters for a block comprising pixels becoming both visible and non-visible upon decoding.

8. The apparatus according to claim 1, wherein the instructions when executed by the at least one processor cause the apparatus at least to perform:
using only a subset of in-loop filters for a block comprising pixels becoming both visible.

9. The apparatus according to claim 1, wherein the instructions when executed by the at least one processor cause the apparatus at least to perform:
applying a combination of in-loop filters block-wise and/or pixel-wise.

10. The apparatus according to claim 1, wherein the instructions when executed by the at least one processor cause the apparatus at least to perform
fully or partially deactivating one or more in-loop filters for a block comprising only pixels not becoming visible upon decoding.

11. The apparatus according to claim 1, wherein the instructions when executed by the at least one processor cause the apparatus at least to perform
signaling one or more parameters about applicability of the in-loop filters in or along a bitstream comprising said video signal.

12. The apparatus according to claim 11, wherein the instructions when executed by the at least one processor cause the apparatus at least to perform
carrying out said signalling in a video parameter set raw byte sequence payload (RBSP) syntax or a sequence parameter set raw byte sequence payload (RBSP) syntax, wherein said signaling comprises a flag indicating activation of reconstruction guided in-loop filtering.

13. A method comprising:
obtaining a video signal comprising blocks of video frames, said blocks comprising a plurality of pixels;
obtaining information indicative about reconstruction or visibility of said pixels in said blocks upon decoding; and
disabling, based on said information indicative about reconstruction or visibility of said pixels in said blocks, in-loop filtering for such blocks having only a subset of the pixels to be reconstructed or visible upon decoding.

14. An apparatus comprising:
at least one processor; and
at least one memory storing instructions that when executed by the at least one processor cause the apparatus at least to perform:
receiving a bitstream comprising an encoded video signal comprising blocks of video frames, said blocks comprising a plurality of pixels;
means for receiving, in or along said bitstream, information indicative about reconstruction or visibility of said pixels in said blocks; and
means for decoding the encoded video signal according to at least said information indicative about reconstruction or visibility of said pixels in said blocks by disabling in-loop filtering for such blocks having only a subset of the pixels to be reconstructed or visible.

15. A method comprising:
receiving a bitstream comprising an encoded video signal comprising blocks of video frames, said blocks comprising a plurality of pixels;
receiving, in or along said bitstream, information indicative about reconstruction or visibility of said pixels in said blocks; and
decoding the encoded video signal according to at least said information indicative about reconstruction or visibility of said pixels in said blocks by disabling in-loop filtering for such blocks having only a subset of the pixels to be reconstructed or visible.

16. The apparatus according to claim 14, wherein the information indicative about reconstruction or visibility of said pixels in said blocks upon decoding is one or more of the following:
an occupancy map video;
an occupancy signal;
an alpha map video;
an alpha channel.

17. The apparatus according to claim 14, wherein the block is one of a coding unit (CU), a prediction unit (PU), a transform unit (TU), a coding tree unit (CTU), a slice or a sub-picture.

18. The apparatus according to claim 14, wherein the instructions when executed by the at least one processor cause the apparatus at least to perform excluding samples corresponding to pixels not becoming reconstructed or visible upon decoding from a filter parameter derivation phase.

19. The apparatus according to claim 14, wherein the instructions when executed by the at least one processor cause the apparatus at least to perform
including only samples corresponding to pixels in a boundary area of pixels being reconstructed or becoming visible and non-visible upon decoding in a filter parameter derivation phase.

20. The apparatus according to claim 19, wherein the instructions when executed by the at least one processor cause the apparatus at least to perform adjusting a filter strength for said samples corresponding to pixels in said boundary area of the pixels being reconstructed or becoming visible and non-visible upon decoding.
